(19) United States
(12) Patent Application Publication
(10) Pub. No.: US 2008/0072321 A1
(43) Pub. Date: Mar. 20, 2008

(54) System and method for automating network intrusion training

(76) Inventor: Mark Wahl, Austin, TX (US)

Correspondence Address: Mark Wahl, PO Box 90626, Austin, TX, 78709, US

(21) Appl. No.: 11/514,593

(22) Filed: Sep. 1, 2006

(51) Int. Cl. G06F 12/14

(52) U.S. Cl. 726/22

(57) ABSTRACT

A system comprising a simulation coordinator, a sensor, and an intrusion detection management component to provide training of intrusion detection administrators by generating simulated notifications of network traffic associated with intrusions.

### FEDERALLY SPONSORED RESEARCH

Not applicable

### SEQUENCE LISTING OR PROGRAM

Not applicable

### BACKGROUND OF THE INVENTION

1. Field of Invention

This invention relates generally to a system and a method for the management of network intrusion detection and computer security systems in enterprise computer networks.

2. Prior Art

A network intrusion detection system deployed within an organization typically collects data from multiple devices or computer systems on that organization's network, analyzes the data for patterns indicating potential intrusions or break in attempts, and produces reports to that organization's network administrator (or administrators). An administrator will review the reports to determine whether to investigate further and potentially take corrective action. This prior art intrusion detection architecture is illustrated in FIG. 5.

U.S. Pat. No. 6,769,066 to Botros et al (2004), and U.S. patent application 20040225627 to Botros et al (2004), both describe methods for training a neural network model for intrusion detection. The methods described in that patent and patent application synthesize input to a neural network, in which the input is derived from user behavior collected in a particular organization. Anomalies are introduced into the input, based on a histogram created “by a modeler or network security analyst”. Because the input to the neural network is derived from existing user behavior, the approach discussed in that patent and patent application is limited, as it cannot represent activities which are distinct to those performed by users within the organization being modeled, such as attacks originating from outside the organization. Furthermore, the methods discussed in that patent and patent application are not suitable for the training of intrusion detection system administrators, as the administrators will be able to detect the anomalies by generating a histogram and comparing it to normal behavior within the system.

U.S. Pat. No. 6,088,804 to Hill et al (2000) describes a system in which a neural network component is provided with a database of simulated attacks. The approach discussed in that patent, however, is not suitable for the training of network system administrators in recognizing anomalous activities which are not handled by the neural network, such as attacks involving types of network traffic never before encountered by the neural network.

U.S. Pat. No. 6,988,208 to Hrabik et al (2006) describes a system in which a pseudo-attack generator creates simulated attacks on a target network, and verifies that the sensors on that network report the attacks, in order to verify the integrity of those sensors. That invention, however, was limited as it does not provide the simulated attack information to the administrators; instead, it compares the output from the intrusion detection system to the attack patterns the system generated.

U.S. Pat. No. 5,961,644 to Kurtzberg et al (1997) describes a method by which computer alarm systems are tested by simulating an attack. The purpose of the invention in that patent is to verify the correct operation of the alarm system, specifically that the alarm produces an appropriate alarm when under simulated attack. The method described in that patent, however, does not cover the monitoring of the behavior of the alarm system's administrators once the alarm has been generated.

U.S. Pat. No. 6,687,748 to Zhang et al (2004) describes a system for network management which includes simulation of network devices. That system includes a simulation device which generates alerts to a network management server, with a goal of testing the network management system. As such, that system is not suitable for providing training of intrusion detection system administrators in a realistic environment, as the network management simulation in that system is kept distinct from the sensors and systems normally used in an intrusion detection system.

U.S. Pat. No. 5,894,566 to Croslin (1999) describes a system for emulating network outages. In the system described in that patent, the network emulator generates simulated timed alerts to indicate the failure of a network. The invention described in that patent is intended for testing the behavior of a centralized system, and would not be able to provide for the training of intrusion detection system administrators using realistic interactions, as the network emulator is not integrated with the production network.

U.S. patent application 20060034305 to Heimerdinger et al (2006) describes a system for anomaly-based intrusion detection. The system described in that application includes the generation of simulated data for use by learning modules, automated components of that system which implement learning algorithms to detect anomalous activities. The invention described in that patent application is limited as it does not describe any mechanisms for the administrators to participate in the process or for the behavior of the administrators in responding to an intrusion or other anomalous activity to be compared to a standard or expected set of behaviors.

U.S. patent application 20030093514 to Valdes et al (2003) describes an intrusion detection system in which alerts generated by that system are ranked using a Bayes network. The invention described in that application is limited as the training process it describes requires the participation of a network manager or other expert to provide a priority ranking of randomly generated alerts in order to improve the output of the Bayes network, and does not enable the system to provide training for the intrusion detection system administrators.

U.S. Pat. No. 5,790,796 to Sadowsky (1998) describes a system for providing updates to software components. The system described in that invention does not specify any activity that a client receiving an update would perform, other than run a generic action to “parse, execute command, or return results”.

### SUMMARY

Many large organizations on the Internet are subjected to frequent attempts to break in by attackers using widely available computer network hacking tools. These tools generate well-known attack patterns that most intrusion detection systems are able to automatically recognize and block. As a result, there may be long periods of time when the administrators will not see any output from the intrusion detection system that requires them to take action, and thus the administrators may not be properly trained for situations that may arise which the intrusion detection is able to recognize as a potential attack, but cannot automatically block.

The purpose of this invention is to provide the administrators of an intrusion detection system for an organization with experience of seeing patterns of network traffic and other operations that are the symptoms of many different forms of attack. This training will assist the administrators when actual attacks based on these patterns are encountered in the future.

In order to make training realistic to an intrusion detection system administrator, patterns of network traffic which indicate anomalous and potential intrusion attempts are caused to be reported by sensors of the intrusion detection system for the organization monitored by that administrator. These patterns are generated by a simulation which causes network traffic to appear to target actual computer systems and resources on the network belonging to that organization. The sensors may be installed on the same computer systems as the resources, on the network, or within a firewall.

### DRAWINGS—FIGURES

FIG. 1 is a diagram illustrating the components of the system for automating network intrusion training.

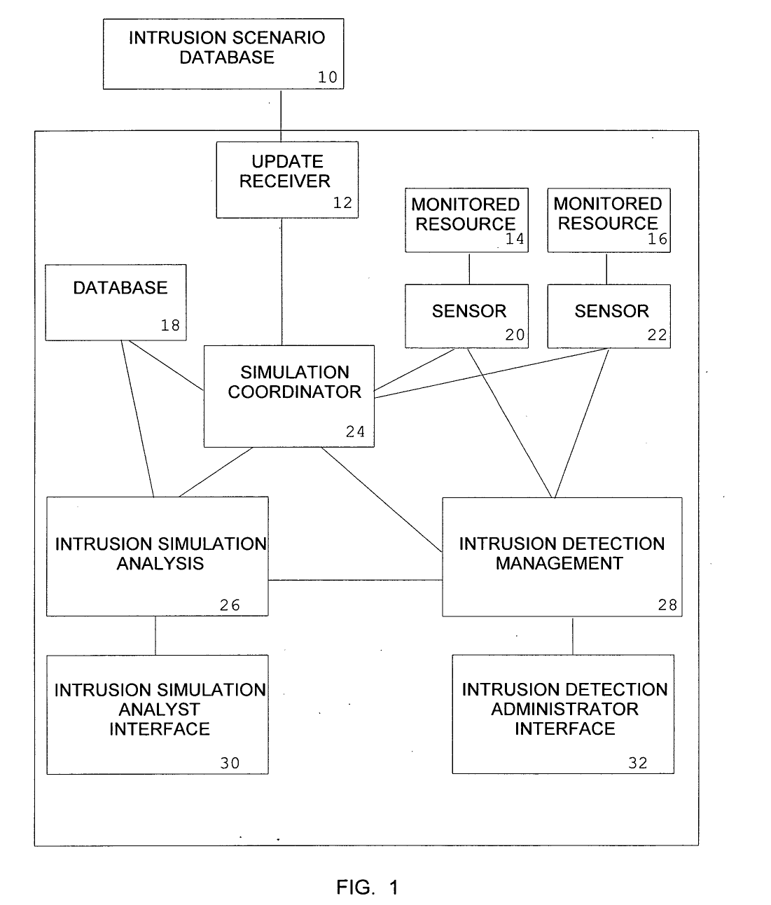

FIG. 2 is a flowchart illustrating a scheduler thread of execution within a simulation coordinator component.

FIG. 3 is a flowchart illustrating a processing thread of execution within a simulation coordinator component.

FIG. 4 is a flowchart illustrating a generation thread of execution within a sensor component.

FIG. 5 is a diagram illustrating the components of a prior art intrusion detection architecture.

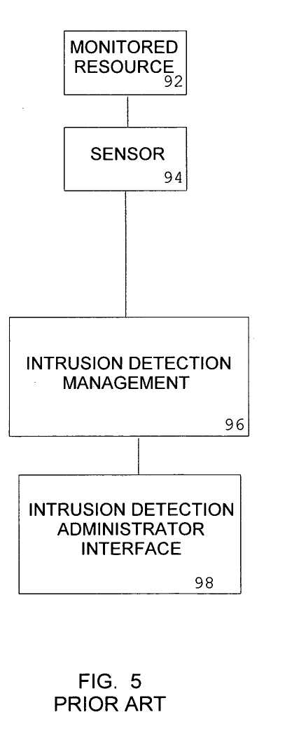

### DRAWINGS—REFERENCE NUMERALS

10 Intrusion scenario database
12 Update receiver
14 Monitored resource
16 Monitored resource
18 Simulation coordinator database
20 Sensor
22 Sensor
24 Simulation coordinator
26 Intrusion simulation analysis
28 Intrusion detection management
30 Intrusion simulation analysis interface
32 Intrusion detection administrator interface
92 Monitored resource
94 Sensor
96 Intrusion detection management
98 Intrusion detection administrator interface

### DETAILED DESCRIPTION

The invention comprises the following components:
An entity, such as a security service provider, develops a set of generic intrusion scenarios. These scenarios are described in general terms (not tied to a particular network's IP addresses) and stored in a database, e.g., a relational database, or a file system (10). The set of scenarios are updated by that entity as new forms of attack are discovered.
An organization running this system for automating network intrusion training obtains these scenarios, and updates to them, through an update receiver (12).
A simulation coordinator (24) is responsible for scheduling a simulated intrusion and managing the interactions between the components responsible for constructing and performing the simulation. The simulation coordinator component will rely on a database (18) of network parameters provided by an intrusion simulation analyst.
An intrusion simulation analysis component (26) and an analyst interface component (30) permits an intrusion simulation analyst to describe the network parameters to be used in training simulations within an organization, and to observe the performance of intrusion detection system administrators when responding to a simulated intrusion.

An intrusion detection management component (28), administrator interface component (32), and sensors (20, 22) represent the typical components of an intrusion detection system.

### These components may be implemented as software running on general-purpose computer systems, or on special purpose devices attached to a network.

### Operation

Prior to the start of a simulation run, it is necessary for the system to obtain a set of one or more intrusion scenarios, and have configured in its database parameters describing the local network topology. The intrusion scenarios could be obtained from a security service provider, or be developed by an intrusion simulation analyst.

If the scenarios are to be obtained from a security service provider, the organization running the system for automating network intrusion training obtains the intrusion scenarios and updates through the update receiver (12). The update receiver may at intervals poll the security service provider to check if there are recent updates, or the security service provider may send updates to each organization that is participating in the service. In order to allow the analysts to vet potential attack scenarios, for example to confirm that they are likely attacks to be encountered on their network, and that the intrusion simulation will not consume excessive resources, the intrusion scenarios are specified in a high-level specialized data description language.

The scenario is described through a specification that includes a set of parameters. Each parameter of a scenario indicates an element of data required from the local database to be used in the simulation, in order to make the simulation appear realistic. (For example, an intrusion involving a compromise of a Microsoft Windows 2000 domain controller system would only appear accurate if the sensor reporting the attack was monitoring such a system).

The specification of an intrusion scenario comprises four sections: a preamble, a resource list, a network event list, and a response list. For transfer between organizations, the specification of an intrusion scenario could be encoded into a text file using an Extensible Markup Language (XML) syntax and schema.

The preamble section specifies:
the type of scenario being generated
what kinds of resources are involved in this simulation, e.g., Windows 2000 domain controllers, or Linux file servers.
the anticipated volume of traffic (in kilobytes) simulated by the network events
the estimated total time (clock time) consumed by the network events
the anticipated level of difficulty in analyzing this scenario

The resource list section comprises a set of resource descriptors. Each descriptor specifies a particular kind or role of a system (e.g., a Windows 2000 domain controller). The intrusion simulation analysis component will assign to each resource a system in the network being managed that has a compatible kind or role of system.

The network event list section comprises an ordered list of network events which will be simulated by the sensors involved in performing the simulation. Each event specifies:
which resources will appear to be involved in this event, e.g., the sender system and recipient system of a packet
which sensor will be generating the event
optionally, a predecessor event
optionally, at what time relative to the start of the simulation the event will be anticipated to occur
the type of network packet that will appear to have caused the event parameters in the network packet that must be filled in by the sensor, e.g., the source and destination IP addresses, or the sequence number the alert or notification messages, if any, to generate to the intrusion detection management component when this event occurs

The response list section comprises an ordered list of activities in the intrusion detection management and intrusion detection administrator interfaces. It will specify the sensors and resource systems which the administrators will be expected to evaluate in order to determine whether this was an actual or simulated attack.

The intrusion simulation analysis component (26) is responsible for updating the database (18) with the topology of sensors and resources on the network. The intrusion simulation analyst, through the analyst interface (30), may further characterize or exclude sensors. The characterization may involve adding descriptive parameters for the resources monitored by the sensors that will allow these resources to be matched with the resource descriptions in the intrusion scenario. For example, the analyst may identify a particular resource as a Microsoft Windows domain controller, so that an intrusion scenario that relies on communication with a Microsoft Windows domain controller may be tailored for the organization. Also, not all sensors are appropriate for use in a simulated attack, and thus some may be excluded. For example, the analyst may wish to exclude sensors monitoring systems which hold high-value data that would set off too many alarms if it appeared to be involved in an intrusion attempt. Also, the analyst may filter the set of potential intrusion scenarios obtained from the intrusion scenario database. In particular, those scenarios which are not applicable to the organization running the simulation or are not appropriate to the administrators being trained, can be removed.

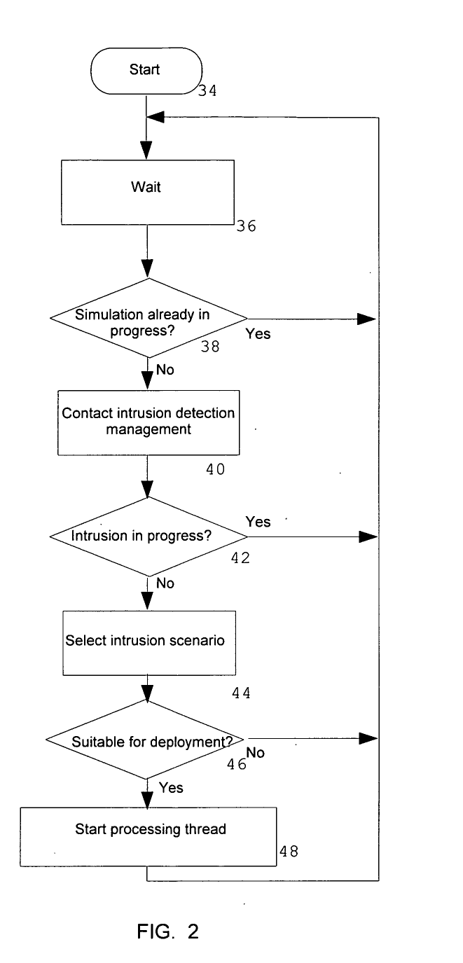

Once the system has been configured, the simulation coordinator (24) will begin the scheduling thread of execution, as described in the flowchart of FIG. 2. After starting (34), the main loop will wait for a random period of time, constrained by a preconfigured minimum or maximum waiting time (36). For example, the minimum waiting time between simulations might be configured to be 24 hours, and the maximum waiting time of three weeks. The thread will then check if there is already a simulation in progress, to avoid confusing the training by running multiple simulations in parallel.

The scheduling thread within the simulation coordinator will then contact the intrusion detection management component (28) to determine whether there is a current intrusion activity in progress (40). If so, the thread will wait until later, in order to avoid delaying an actual investigation (42). The scheduling thread will select an intrusion scenario from the database (44), and determine if it is suitable for the deployment as currently configured (46). If it is appropriate, then the scheduling thread will start the processing thread within the simulation coordinator (48).

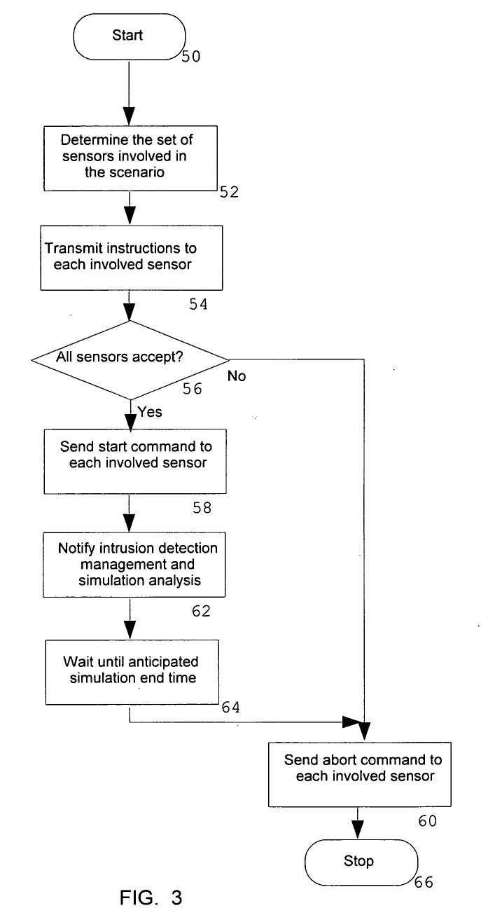

The processing thread within the simulation coordinator is illustrated by the flowchart of FIG. 3. After being started by the scheduling thread (50), this thread will identify the set of sensors that will be involved in running the test scenario (52). This thread will then send instructions to each sensor specifying the traffic patterns that the sensor should appear to be receiving (the packets that would occur were this to be an actual intrusion) (54). If all sensors are available and accept the scenario's instructions, then the thread will send the start command to each of the involved sensors (58). Otherwise if any of the sensors are unavailable or cannot perform the scenario, then the thread will send the abort command to all the involved sensors (60).

Once the start command has been sent, the processing thread will notify the intrusion detection management and intrusion simulation analysis components that a simulation has started (62), and then wait until the anticipated end of the simulation, after all the simulated traffic notifications have been sent (64).

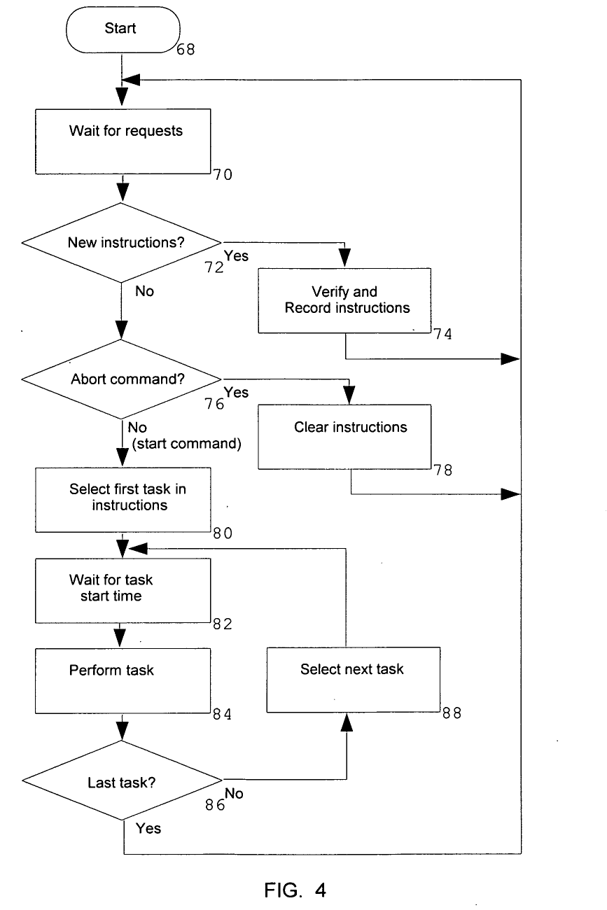

A sensor will include an additional generation thread, as illustrated in the flowchart in FIG. 4. This thread is started when the sensor begins operation (68), and will wait for requests from a simulation coordinator (70). When the sensor receives new instructions from the coordinator, this thread will verify that the instructions are appropriate for this sensor, and if so record them, either in memory or in a local database (72,74). If the sensor receives an abort command, this thread will clear these instructions (76,78). After receiving a start command, the thread will iterate through the tasks in the instructions (80, 86, 88). For each task, the thread will wait for the start time or trigger event for the task (82), and then perform the task (84). For a sensor monitoring a network segment or device for packets (data on the network), the thread will simulate the reception or transmission of a network packet, typically resulting in the main sensor logic reporting the packet to the intrusion detection management through its normal channels.

The intrusion detection management component will register when the administrators have started investigation of a potential intrusion, and track the sensors whose data the administrators monitor. Subsequent to a simulated intrusion, the intrusion simulation analysis component will fetch this information from the intrusion detection management component.

Based on this, the intrusion simulation analysis component will be able to determine whether the administrators took action in response to a simulated attack.

The resulting information of the administrator interactions with the intrusion detection system may be compared with the anticipated actions that are included in the simulated intrusion scenarios. If the administrators analyzing the output of the intrusion detection system ignore a high potential simulation attack, this may indicate a failure in the reporting or interpretation of the intrusion detection system's output. (For example, such a failure may be as simple as the email address for an administrator to which the intrusion detection system is reporting attacks is no longer active). If the administrators used incorrect methods for investigating the attack, and did not examine the correct resources, the system can suggest the recommended methods.

### ALTERNATIVE EMBODIMENTS

An alternative implementation, the intrusion simulation analysis component (26) could provide the network parameters developed by the intrusion simulation analyst to an external security service provider (10), and as a result the update receiver (12) would only receive scenarios that are appropriate to the organization, and that are already appropriately configured.

As an alternative implementation, the checks performed by the simulation coordinator component prior to starting a simulation could be removed or modified to allow certain simulations to running concurrently with other simulations or investigations in progress for non-simulated intrusions, as it will more realistically simulate Internet behavior, in which there may be multiple simultaneous coordinated or uncoordinated attacks.

### CONCLUSIONS

Many different embodiments of this invention may be constructed without departing from the scope of this invention. While this invention is described with reference to various implementations and exploitations, and in particular with respect to intrusion detection systems, it will be understood that these embodiments are illustrative and that the scope of the invention is not limited to them.

What is claimed is:

1. A system comprising:
(a) a software service component configured as a simulation coordinator;
(b) a sensor component configured to detect patterns of network traffic;
(c) an intrusion detection management component;
(d) a database component configured to store patterns of intrusion scenarios;
(e) a software service component configured to provide intrusion simulation analysis; and
(f) a software application component configured as an intrusion simulation analyst interface;
whereby said software service component configured as a simulation coordinator will transmit a set of instructions to said sensor component, and said sensor component will send to said intrusion detection management component notifications of having received traffic as instructed by said software service component configured as a simulation coordinator.

2. The system of claim 1, wherein said software component configured as a simulation coordinator, said intrusion detection management component, said database component, said software service component configured to provide intrusion simulation analysis, and said software application component configured as an intrusion simulation analyst interface are implemented as software running on a general-purpose computer system.

3. The system of claim 1, wherein said sensor component is implemented as software running on a general-purpose computer system.

4. The system of claim 1, wherein said sensor component is implemented as a special-purpose monitoring device attached to a computer network.

5. The system of claim 1, wherein said sensor component is implemented as a firewall device attached to a computer network.

6. The system of claim 1, wherein said software application component configured as an intrusion simulation analyst interface is implemented as a web application.

7. The system of claim 1, wherein said database is implemented as a relational database.

8. The system of claim 1, wherein patterns of intrusion scenarios in said database are obtained from an intrusion scenario database operated by a security service provider.

9. The system of claim 1, wherein said software service component configured to provide intrusion simulation analysis compares activities performed in said intrusion detection management component with the anticipated performance in an intrusion scenario.

10. A method for automating network intrusion training, comprising:
(a) providing a software service for coordinating a simulation;
(b) providing a sensor component configured to detect patterns of network traffic;
(c) providing an intrusion detection management component;
(d) providing a database component configured to store patterns of intrusion scenarios;
(e) providing a software service for intrusion simulation analysis; and
(f) providing a software application configured as an intrusion simulation analyst interface;
whereby said software service for coordinating a simulation will transmit a set of instructions to said sensor component, and said sensor component will send to said intrusion detection management component notifications of having received traffic as instructed by said software service for coordinating a simulation.

11. The method of claim 10, wherein patterns of intrusion scenarios in said database component are obtained from an intrusion scenario database operated by a security service provider.

12. The method of claim 10, wherein said database component is accessed by said software component for coordinating a simulation using a structured query language.

13. The method of claim 10, wherein said software service for intrusion simulation analysis compares activities performed in said intrusion detection management component with the anticipated performance in an intrusion scenario.
